(19) United States
(12) Patent Application Publication
(10) Pub. No.: US 2025/0240070 A1
(43) Pub. Date: Jul. 24, 2025

(54) TERMINAL, RADIO COMMUNICATION METHOD, AND BASE STATION

(71) Applicant: NTT DOCOMO, INC., Tokyo (JP)

(72) Inventors: Haruhi Echigo, Tokyo (JP); Hiroki Harada, Tokyo (JP); Xufei Zheng, Beijing (CN); Liu Liu, Beijing (CN); Jing Wang, Beijing (CN); Yujia Shan, Beijing (CN)

(73) Assignee: NTT DOCOMO, INC., Tokyo (JP)

(21) Appl. No.: 18/685,419

(22) PCT Filed: Aug. 25, 2021
(86) PCT No.: PCT/JP2021/031217

§ 371 Date: Feb. 21, 2024

(51) Int. Cl. H04B 7/06; H04L 5/00; H04W 24/10

(52) U.S. Cl. CPC H04B 7/0626; H04L 5/0094; H04W 24/10

(57) ABSTRACT

A terminal according to one aspect of the present disclosure includes a receiving section that receives one channel state information (CSI) report configuration, and a control section that performs control of transmitting first CSI at a first timing and second CSI being different from the first CSI at a second timing being different from the first timing, based on the one CSI report configuration. According to one aspect of the present disclosure, preferable channel estimation/use of resources can be implemented.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G),” “5G+ (plus),” “6th generation mobile communication system (6G),” “New Radio (NR),” “3GPP Rel. 15 (or later versions),” and so on) are also under study.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

Regarding future radio communication technology, utilizing artificial intelligence (AI) technology such as machine learning (ML) for control, management, and the like of a network/device has been under study. For example, AI-aided beam management using AI-aided estimation (AI-aided estimation) has been under study.

However, studies on specific details of AI-aided beam management have not yet been carried out. Unless these are appropriately defined, high-accuracy channel estimation/high-efficiency use of resources cannot be achieved, which may hinder enhancement of communication throughput or communication quality.

In view of this, the present disclosure has one object to provide a terminal, a radio communication method, and a base station for enabling implementation of preferable channel estimation/use of resources.

### Solution to Problem

A terminal according to one aspect of the present disclosure includes a receiving section that receives one channel state information (CSI) report configuration, and a control section that performs control of transmitting first CSI at a first timing and second CSI being different from the first CSI at a second timing being different from the first timing, based on the one CSI report configuration.

### Advantageous Effects of Invention

According to one aspect of the present disclosure, preferable channel estimation/use of resources can be implemented.

### BRIEF DESCRIPTION OF DRAWINGS

FIGS. 1A and 1B are diagrams to show examples of complementary CSI feedback according to a first embodiment.

FIG. 2 is a diagram to show an example of prediction of full CSI based on the complementary CSI feedback according to the first embodiment.

FIGS. 3A and 3B are diagrams to show examples of the complementary CSI feedback based on a comb pattern.

FIGS. 4A and 4B are diagrams to show examples of the complementary CSI feedback based on a bitmap pattern.

FIGS. 5A and 5B are diagrams to show examples of the complementary CSI feedback based on a group.

FIG. 6 is a diagram to show an example in which the pattern to be applied to the complementary CSI feedback is determined based on CSI information.

FIGS. 7A and 7B are diagrams to show examples of reduced CSI feedback according to a second embodiment.

FIG. 8 is a diagram to show an example of prediction of full CSI based on the reduced CSI feedback according to the second embodiment.

FIGS. 9A and 9B are diagrams to show examples of determination of details of the reduced CSI feedback according to the second embodiment.

FIG. 10 is a diagram to show an example of a schematic structure of a radio communication system according to one embodiment.

FIG. 11 is a diagram to show an example of a structure of a base station according to one embodiment.

FIG. 12 is a diagram to show an example of a structure of a user terminal according to one embodiment.

FIG. 13 is a diagram to show an example of a hardware structure of the base station and the user terminal according to one embodiment.

### DESCRIPTION OF EMBODIMENTS

### (Application of Artificial Intelligence (AI) Technology to Radio Communication)

Regarding future radio communication technology, utilizing AI technology for control, management, and the like of a network/device has been under study.

For example, regarding future radio communication technology, increasing accuracy of channel estimation (which may be referred to as channel measurement) has been desired for beam management, decoding of a received signal, and the like in communication using beams in particular.

For example, channel estimation may be performed using at least one of a channel state information reference signal (CSI-RS), a synchronization signal (SS), a synchronization signal/broadcast channel (Synchronization Signal/Physical Broadcast Channel (SS/PBCH)) block, a demodulation reference signal (DMRS), a reference signal for measurement (Sounding Reference Signal (SRS)), and the like.

In radio communication technology thus far, in order to perform high-accuracy channel estimation, a large amount of resources for estimation (for example, resources for transmitting reference signals) are required, and channel estimation is required for all of antenna ports used. When resources such as the DMRS and the CSI-RS are increased in order to implement high-accuracy channel estimation, resources (for example, downlink shared channel (Physical Downlink Shared Channel (PDSCH)) resources and uplink shared channel (Physical Uplink Shared Channel (PUSCH)) resources) for transmission and reception of data are reduced.

In the radio communication technology thus far, control based on the current or past measurement results can be performed; however, when a link is disconnected due to deterioration of radio quality or the like, there is a delay in coping with the disconnection.

Studies are carried out on future implementation of high-accuracy channel estimation using less resources and measurement for future prediction, by means of AI technology such as machine learning (ML). Such channel estimation may be referred to as AI-aided estimation (AI-aided estimation). Beam management using AI-aided estimation may be referred to as AI-aided beam management.

As an example of AI-aided beam management, when AI is used in a terminal (also referred to as a user terminal, a User Equipment (UE), or the like), AI may predict a future beam measurement value, or may estimate (derive) a measurement value of a large number of beams based on a small number of beams. The UE may trigger enhanced beam failure recovery (enhanced BFR) with prediction.

As an example of AI-aided beam management, when AI is used in a base station (BS), AI may predict a future beam measurement value (for example, a measurement value of a fine beam), or may estimate (derive) a measurement value of a fine beam based on management of a small number of beams. The UE may receive a beam indication with a time offset.

However, studies on specific details of AI-aided beam management have not yet been carried out. Unless these are appropriately defined, high-accuracy channel estimation/high-efficiency use of resources cannot be achieved, which may hinder enhancement of communication throughput or communication quality.

In view of this, the inventors of the present invention came up with the idea of CSI feedback preferable for AI-aided beam management. Note that each embodiment of the present disclosure may be applied when AI/prediction is not used.

In one embodiment of the present disclosure, the UE/BS performs training of an ML model in a training mode, and implements the ML model in a test mode (also referred to as a testing mode or the like). In the test mode, verification (validation) of accuracy of the ML model (trained ML model) trained in the training mode may be performed.

In the present disclosure, the UE/BS may input channel state information, a reference signal measurement value, and the like to the ML model, and output high-accuracy channel state information/measurement value/beam selection/position, future channel state information/radio link quality, and the like.

Note that, in the present disclosure, AI may be interpreted as an object (also referred to as a subject, data, a function, a program, or the like) that has (implements) at least one of the following features:
estimation based on observed or collected information,
selection based on observed or collected information,
prediction based on observed or collected information.

In the present disclosure, the object may be, for example, an apparatus, a device, or the like, such as the terminal and the base station. The object may be a program included in the apparatus.

In the present disclosure, the ML model may be interpreted as an object that has (implements) at least one of the following features:
generating an estimation value through feeding of information,
predicting an estimation value through feeding of information,
finding a feature through feeding of information,
selecting an operation through feeding of information.

In the present disclosure, the ML model may be interpreted as at least one of an AI model, predictive analytics, a predictive analytics model, and the like. The ML model may be derived using at least one of regression analysis (for example, linear regression analysis, multiple regression analysis, or logistic regression analysis), a support vector machine, a random forest, a neural network, deep learning, and the like. In the present disclosure, the model may be interpreted as at least one of an encoder, a decoder, a tool, and the like.

The ML model outputs information of at least one of an estimation value, a prediction value, a selected operation, a class, and the like, based on input information.

In the ML model, supervised learning, unsupervised learning, reinforcement learning, and the like may be included. Supervised learning may be used for learning general rules of mapping input to output. Unsupervised learning may be used for learning features of data. Reinforcement learning may be used for learning an operation for maximizing a target (goal).

Each embodiment to be described later will be described mainly on an assumption of a case in which supervised learning is used for the ML model, but this is not restrictive.

In the present disclosure, implement, use, operate, execute, and the like may be interchangeably interpreted. In the present disclosure, a test, after-training, real use, actual use, and the like may be interchangeably interpreted. A signal may be interchangeably interpreted as a signal/channel.

In the present disclosure, the training mode may be a mode in which the UE/BS transmits/receives a signal for the ML model (that is, an operation mode in a training period). In the present disclosure, the test mode may be a mode in which the UE/BS implements the ML model (for example, implements the trained ML model and predicts output) (that is, an operation mode in a test period).

In the present disclosure, the training mode may mean, with respect to a specific signal to be transmitted in the test mode, a mode in which the specific signal having large overhead (for example, having a large amount of resources) is transmitted.

In the present disclosure, the training mode may mean a mode in which first configuration (for example, first DMRS configuration or first CSI-RS configuration) is referred to. In the present disclosure, the test mode may mean a mode in which second configuration (for example, second DMRS configuration or second CSI-RS configuration), which is different from the first configuration, is referred to. In the first configuration, at least one of time resources, frequency resources, code resources, and ports (antenna ports) related to measurement may be configured in a larger amount than in the second configuration.

Embodiments according to the present disclosure will be described in detail with reference to the drawings as follows. The radio communication methods according to respective embodiments may each be employed individually, or may be employed in combination.

In the following embodiments, the ML model related to communication between the UE and the BS will be described, and related entities are thus the UE and the BS. However, application of each embodiment of the present disclosure is not limited to this. For example, regarding communication between other entities (for example, communication between UEs), the UE and the BS in the following embodiments may be interpreted as a first UE and a second UE. In other words, the UE, the BS, and the like in the present disclosure may each be interpreted as any UE/BS.

In the present disclosure, “A/B” and “at least one of A and B” may be interchangeably interpreted.

In the present disclosure, activate, deactivate, indicate, select, configure, update, determine, and the like may be interchangeably interpreted. In the present disclosure, “support,” “control,” “controllable,” “operate,” and “operable” may be interchangeably interpreted.

In the present disclosure, radio resource control (RRC), an RRC parameter, an RRC message, a higher layer parameter, an information element (IE), and a configuration may be interchangeably interpreted. In the present disclosure, a Medium Access Control control element (MAC Control Element (CE)), an update command, and an activation/deactivation command may be interchangeably interpreted.

In the present disclosure, a panel, a UE panel, a panel group, a beam, a beam group, a precoder, an Uplink (UL) transmission entity, a TRP, spatial relation information (SRI), a spatial relation, an SRS resource indicator (SRI), an SRS resource, a control resource set (CORESET), a Physical Downlink Shared Channel (PDSCH), a codeword, a base station, a reference signal, a given antenna port (for example, a demodulation reference signal (DMRS) port), a given antenna port group (for example, a DMRS port group), a given group (for example, a code division multiplexing (CDM) group, a given reference signal group, or a CORESET group), a given resource (for example, a given reference signal resource), a given resource set (for example, a given reference signal resource set), a CORESET pool, a PUCCH group (PUCCH resource group), a spatial relation group, a downlink Transmission Configuration Indication state (TCI state) (DL TCI state), an uplink TCI state (UL TCI state), a unified TCI state, a common TCI state, quasi-co-location (QCL), QCL assumption, and the like may be interchangeably interpreted.

In the present disclosure, an index, an ID, an indicator, and a resource ID may be interchangeably interpreted. In the present disclosure, a sequence, a list, a set, a group, a cluster, a subset, and the like may be interchangeably interpreted.

In the present disclosure, a beam report may be interchangeably interpreted as a beam measurement report, a CSI report, a CSI measurement report, a prediction beam report, a prediction CSI report, and the like.

In the present disclosure, a CSI-RS may be interchangeably interpreted as at least one of a non zero power (NZP) CSI-RS, a zero power (ZP) CSI-RS, and a CSI interference measurement (CSI-IM).

In the present disclosure, an RS to be measured/reported may mean an RS to be measured/reported for a beam report.

Note that, in the present disclosure, timing, time point, time, a slot, a sub-slot, a symbol, a subframe, and the like may be interchangeably interpreted.

Note that, in the present disclosure, a direction, an axis, a dimension, polarization, a polarization component, and the like may be interchangeably interpreted.

Note that, in the present disclosure, estimation, prediction, and inference may be interchangeably interpreted. In the present disclosure, estimate, predict, and infer may be interchangeably interpreted.

Note that, in the present disclosure, an RS may be a CSI-RS, an SS/PBCH block (SS block (SSB)), or the like, for example. An RS index may be a CSI-RS resource indicator (CRI), an SS/PBCH block resource indicator (SS/PBCH Block Indicator (SSBRI)), or the like.

Note that, in the present disclosure, CSI feedback, CSI feedback information, a CSI report, CSI transmission, CSI information, CSI, and the like may be interchangeably interpreted.

In the present disclosure, a subband may be interchangeably interpreted as a physical resource block (PRB), a subcarrier, any frequency resource unit, and the like.

### (Radio Communication Method)

### First Embodiment

A first embodiment relates to complementary CSI feedback.

When the complementary CSI feedback is used, the BS having AI may predict full CSI information, based on a correlation between past feedbacks having a complementary part.

CSI estimation using the complementary CSI feedback may be performed in accordance with the following Steps S101 and S102.

In Step S101, the UE transmits the CSI feedback information of a partial subband (which may be simply interpreted as a subband) to the BS. The CSI feedback information of the partial subband as described above may be referred to as partial CSI, complementary CSI, or the like. Partial CSIs being adjacent with respect to time may include information complementary to each other. Note that a case in which a plurality of partial CSIs are adjacent with respect to time may mean that one of the plurality of partial CSIs is to be transmitted i times after (i is an integer; “i=1” means immediately after (next)) transmission of another partial CSI.

Note that, in the present disclosure, the partial CSI may be reported periodically/semi-persistently/aperiodically. In other words, a transmission timing of the partial CSI may be present periodically/semi-persistently/aperiodically.

In Step S102, the BS may predict the full CSI information at a future time (for example, specific transmission time interval (TTI), slot, or the like), using an AI model, based on the partial CSI transmitted in Step S101.

Note that the full CSI information may mean the CSI information regarding the entire subband corresponding to each partial CSI.

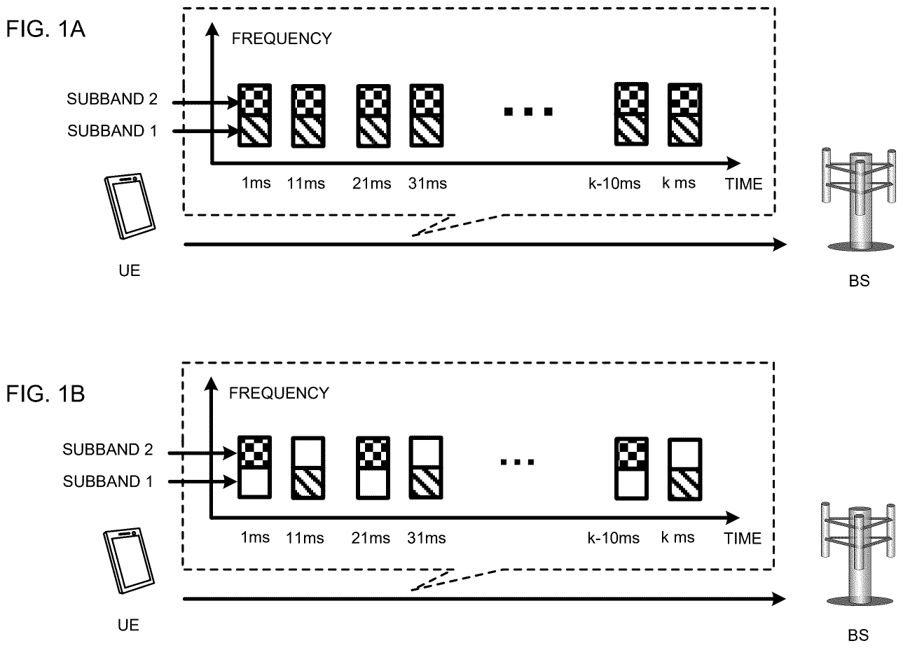

FIGS. 1A and 1B are diagrams to show examples of the complementary CSI feedback according to the first embodiment. In the present example, it is assumed that non-overlapping subbands 1 and 2 constitute the entire CSI reporting band. Note that, in the present disclosure, an entire CSI reporting band, a CSI reporting band, and a wideband may be interchangeably interpreted.

In the present example, it is assumed that the UE performs CSI feedback from a time at 1 ms with a period of 10 ms, with 0 being a given time. Note that, although an example will be described in which k is represented by “1 added to a multiple of 10”, application of the embodiments of the present disclosure is not limited to this. The time of k may correspond to the current time, for example. Note that ms (millisecond) of the present disclosure may be interpreted as any time unit, such as one or more slots and one or more symbols.

FIG. 1A shows an example in which full CSI feedback is performed from the beginning, unlike the first embodiment. In FIG. 1A, the UE feeds back subband CSIs regarding subbands 1 and 2, respectively.

FIG. 1B shows an example in which the complementary CSI feedback is performed. In FIG. 1B, the UE feeds back only the CSI of subband 2 at odd-numbered (times at 1 ms, 21 ms, . . . ) feedback timings, and feeds back only the CSI of subband 1 at even-numbered (times at 11 ms, 31 ms, . . . ) feedback timings. It can be understood that, in FIG. 1B, communication overhead for CSI feedback is reduced as compared to that of FIG. 1A.

Note that some details are similar to those of FIGS. 1A and 1B in the following drawings as well, and thus overlapping description will not be repeated. A frequency resource (bandwidth) in one quadrilateral in each drawing corresponds to one or more subbands (or subband group(s) to be described later).

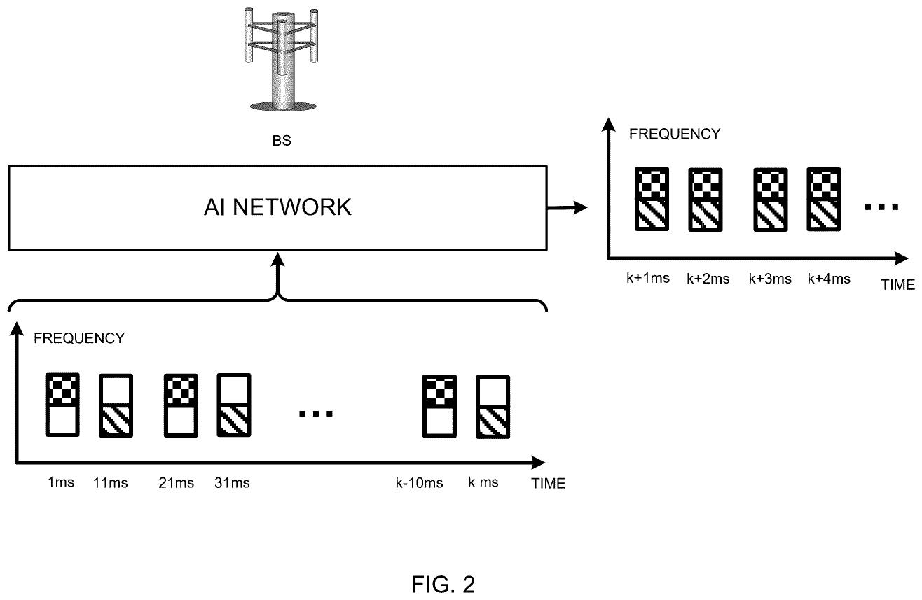

FIG. 2 is a diagram to show an example of prediction of full CSI based on the complementary CSI feedback according to the first embodiment.

In FIG. 2, the BS inputs the complementary CSI feedback up to the time k ms received from the UE to an AI model (AI network), and predicts the full CSI at and after the time k+1.

Note that, in the present example, regarding the time k+1 and later, the full CSI with a period 1 ms is predicted. In this manner, prediction of the full CSI of the first embodiment may be used for prediction of the full CSI with a period/timing different from a transmission period of the complementary CSI feedback. Prediction of the full CSI of the first embodiment may be used for prediction of the full CSI at the transmission timing of the complementary CSI feedback.

Note that, in the present disclosure, a transmission timing, a feedback timing, a transmission occasion, and the like may be interchangeably interpreted.

Note that, in the present disclosure, as CSI measurement for the complementary CSI feedback, the UE may perform CSI measurement of each subband of the entire CSI reporting band (i.e., may perform CSI measurement also regarding the subbands not to be reported), or may perform CSI measurement of only the subbands to be reported. In the former case, measurement results of the subbands not to be reported can be used for control/processing, whereas in the latter case, a measurement load of the UE can be reduced.

### [Determination of Subband to be Reported]

The UE may determine the CSI of which subband is to be reported in the complementary CSI feedback at a given timing, based on at least one of the following:
Pattern 1: comb,
Pattern 2: bitmap,
Pattern 3: subband group.

Patterns 1 to 3 (or combinations of these) may each be referred to as a pattern type (a type of a pattern). Note that one or more subbands indicated by patterns 1 to 3 (or combinations of these) may be referred to as a set of subbands.

In a case of pattern 1, the UE may determine a pattern of a comb of the subband based on a comb value and a comb offset, and report the CSI of the subband included in the pattern. The comb value may indicate a period of the subbands to be reported, and the comb offset may indicate a start subband of the subbands to be reported. The comb offset may have a value of an integer equal to or greater than 0 and less than the comb value.

For example, comb value=2 and comb offset=0 may indicate a set of even-numbered subbands of the entire CSI reporting band, and comb value=2 and comb offset=1 may indicate a set of odd-numbered subbands of the entire CSI reporting band.

Regarding the comb value and the comb offset for the complementary CSI feedback at a given timing, the UE may perform determination based on a specific rule, may be configured using physical layer signaling (for example, downlink control information (DCI)), higher layer signaling (for example, RRC signaling or a MAC CE), or a specific signal/channel, or a combination of these, or may perform determination based on a UE capability.

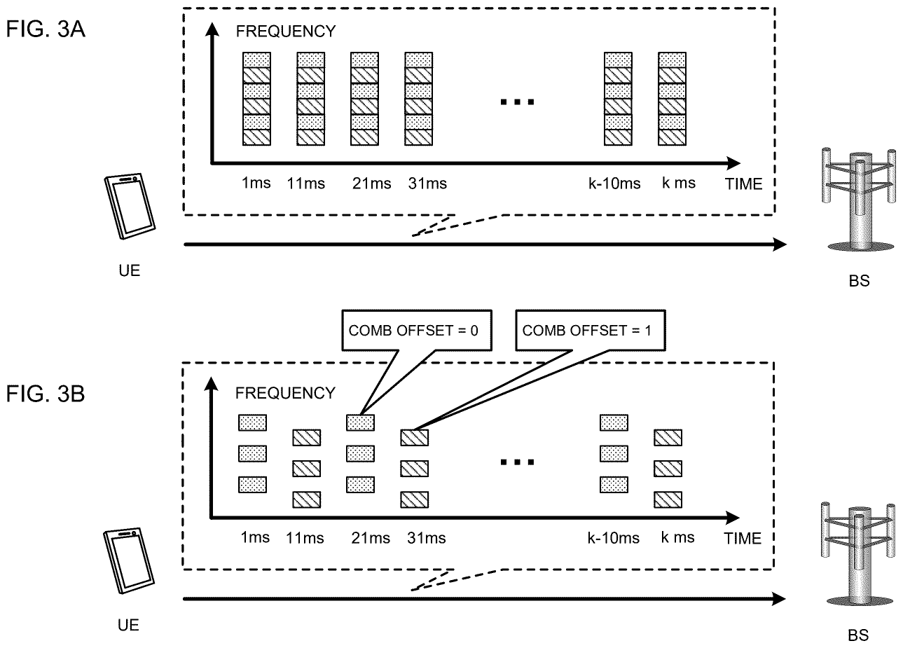

FIGS. 3A and 3B are diagrams to show examples of the complementary CSI feedback based on the comb pattern. FIG. 3A shows an example in which the full CSI feedback is performed from the beginning, unlike the first embodiment. In FIG. 3A, the UE feeds back the subband CSIs regarding respective subbands in the CSI reporting band, respectively.

In FIG. 3B, the UE feeds back only the CSI of the subband corresponding to the comb pattern based on comb value=2 and comb offset=0 at odd-numbered (times at 1 ms, 21 ms, . . . ) feedback timings, and feeds back only the CSI of the subband corresponding to the comb pattern based on comb value=2 and comb offset=1 at even-numbered (times at 11 ms, 31 ms, . . . ) feedback timings.

In a case of pattern 2, the UE may report the CSI of the subband indicated by a bitmap. The size of the bitmap may be the number of subbands included in the entire CSI reporting band. The UE may report the subband corresponding to value of the bitmap=‘1’ and determine not to report the subband corresponding to value=‘0’ (note that these values may be the opposite). In the bitmap, the most significant bit (MSB) may correspond to the largest subband or may correspond to the smallest subband of the entire CSI reporting band.

Regarding the bitmap for the complementary CSI feedback at a given timing, the UE may perform determination based on a specific rule, may be configured using physical layer signaling (for example, DCI), higher layer signaling (for example, RRC signaling or a MAC CE), or a specific signal/channel, or a combination of these, or may perform determination based on a UE capability.

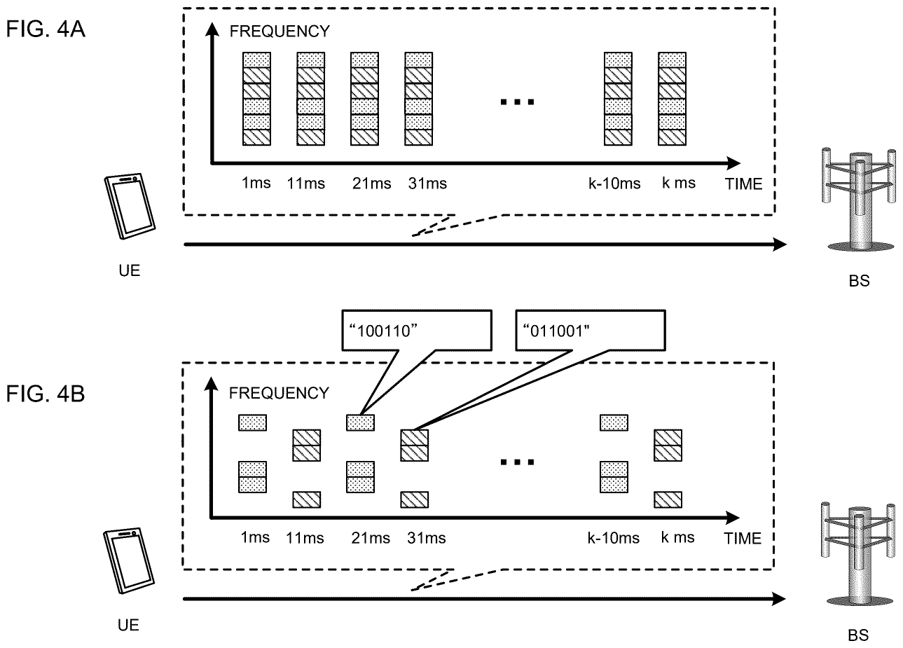

FIGS. 4A and 4B are diagrams to show examples of the complementary CSI feedback based on the bitmap pattern. FIG. 4A shows an example in which the full CSI feedback is performed from the beginning, unlike the first embodiment. In FIG. 4A, the UE feeds back the subband CSIs regarding respective subbands in the CSI reporting band, respectively.

In FIG. 4B, the UE feeds back only the CSI of the subband corresponding to the bitmap pattern based on bitmap=“100110” at odd-numbered (times at 1 ms, 21 ms, . . . ) feedback timings, and feeds back only the CSI of the subband corresponding to the bitmap pattern based on bitmap=“011001” at even-numbered (times at 11 ms, 31 ms, . . . ) feedback timings.

In a case of pattern 3, the UE may determine the subband group based on a group offset (which may be referred to as a group index), and report the CSI of the subband included in the group. The number of subbands in the group may be different or may be the same for each group.

For example, group offset=0 may indicate a set of group 1 of the entire CSI reporting band, and group offset=1 may indicate a set of group 2 of the entire CSI reporting band.

Note that the UE may assume that one subband group is constituted of consecutive subbands. The UE may determine the subbands constituting each group (included in each group) from the number of subband groups. Note that, regarding the number of subband groups, the number of subbands in the group, and the like, the UE may perform determination based on a specific rule, may be configured using physical layer signaling (for example, DCI), higher layer signaling (for example, RRC signaling or a MAC CE), or a specific signal/channel, or a combination of these, or may perform determination based on a UE capability.

Regarding the group offset/the number of subbands in the group for the complementary CSI feedback at a given timing, the UE may perform determination based on a specific rule, may be configured using physical layer signaling (for example, DCI), higher layer signaling (for example, RRC signaling or a MAC CE), or a specific signal/channel, or a combination of these, or may perform determination based on a UE capability.

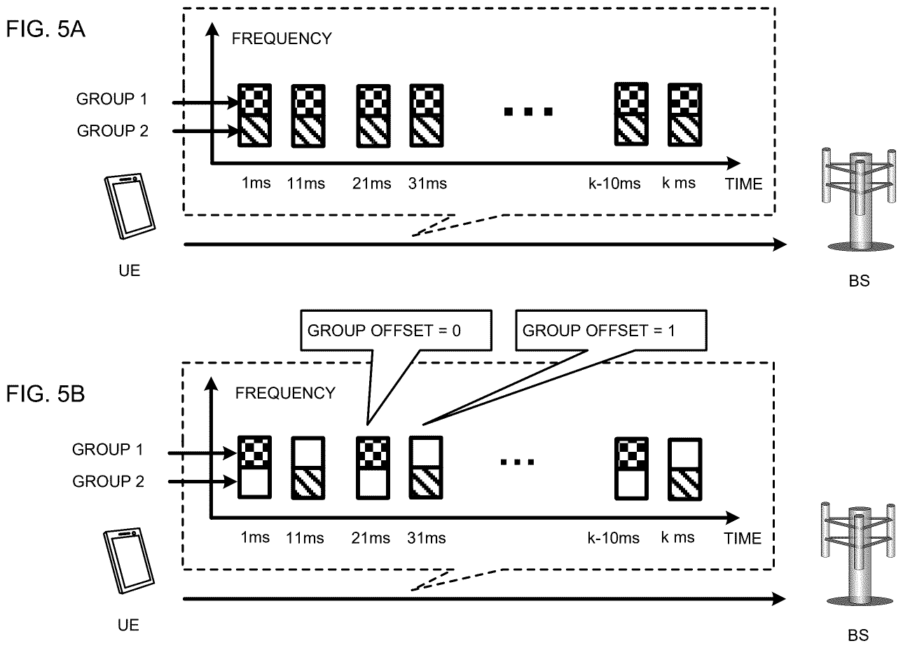

FIGS. 5A and 5B are diagrams to show examples of the complementary CSI feedback based on the group. FIG. 5A shows an example in which the full CSI feedback is performed from the beginning, unlike the first embodiment. In FIG. 5A, the UE feeds back the subband CSIs regarding respective subbands in the CSI reporting band (in each group), respectively.

In FIG. 5B, the UE feeds back only the CSI of the subband corresponding to group 1 based on group offset=0 at odd-numbered (times at 1 ms, 21 ms, . . . ) feedback timings, and feeds back only the CSI of the subband corresponding to group 2 based on group offset=1 at even-numbered (times at 11 ms, 31 ms, . . . ) feedback timings.

Note that, regarding which pattern type is used at which timing (and a more specific pattern configuration as described above), the UE may perform determination based on a specific rule, may be configured using physical layer signaling (for example, DCI), higher layer signaling (for example, RRC signaling or a MAC CE), or a specific signal/channel, or a combination of these, or may perform determination based on a UE capability. For example, the UE may be configured with information related to at least one of the comb, the bitmap, and the subband group described above, using a higher layer parameter together with timing information (for example, a period or an offset) to be applied.

For example, the UE may be configured with a plurality of (for example, N) bit strings indicating the subband/subband group to be reported as the CSI reporting band (RRC parameter csi-ReportingBand) in the CSI report configuration (RRC information element CSI-ReportConfig). The UE may determine the subband/subband group to be reported at (Nj+i)-th (j=0, 1, . . . ) feedback timings based on a reporting period, based on an i-th (i is an integer) bit string of the plurality of bit strings configured.

The UE may determine which pattern type is used at which timing (and a more specific pattern configuration as described above), based on the CSI information. For example, the UE may calculate a difference between the CSI (also including the CSI not to be reported) measured at the time of a previous report and the CSI measured at present, and determine (the pattern corresponding to) the subband to be reported based on this. The UE may determine X subsets that have changed the most (from the one with the largest difference) from the CSI measured at the time of a previous report as a report target of the complementary CSI feedback. Here, the subset may be interchangeably interpreted as a subband, a subband group, or the like. Note that the subsets as a report target may be determined from a subset whose difference has exceeded a threshold.

Note that, in the present disclosure, “the CSI measured at the time of a previous report” may be interpreted as “previously reported CSI”. “Previous” may be interchangeably interpreted as “last”, “i times before (i is an integer)”, and the like.

Regarding the value of X, the threshold, and the like, the UE may perform determination based on a specific rule, may be configured using physical layer signaling (for example, DCI), higher layer signaling (for example, RRC signaling or a MAC CE), or a specific signal/channel, or a combination of these, or may perform determination based on a UE capability.

The UE may include, in the complementary CSI feedback, information indicating on which pattern type the report is based (and a more specific pattern configuration as described above).

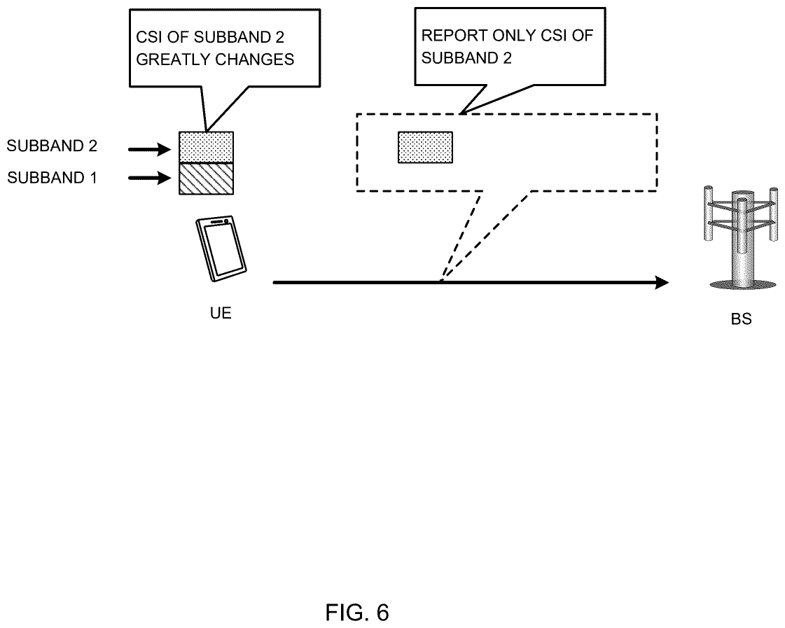

FIG. 6 is a diagram to show an example in which the pattern to be applied to the complementary CSI feedback is determined based on the CSI information. In the present example, it is assumed that X=1. On the assumption that only the CSI of subband 2 of the subband CSIs of respective subbands 1 and 2 measured at present greatly changes from measurement of a previous report above a threshold, the UE reports only the CSI of subband 2 as the current complementary CSI feedback.

Note that, although the foregoing description assumes that a plurality of complementary CSI feedbacks include non-overlapping subband CSIs, this is not restrictive. For example, adjacent (the latest) complementary CSI feedbacks may include the subband CSI related to the same subband.

According to the first embodiment described above, the UE can implement the complementary CSI feedback with low overhead.

### Second Embodiment

A second embodiment relates to reduced CSI feedback with different priorities. The CSI feedback is hereinafter also simply referred to as reduced CSI feedback. In the present disclosure, a priority may be interchangeably interpreted as a priority level, a priority value, or simply a level or the like.

When the reduced CSI feedback is used, the BS having AI may predict the full CSI information, based on a correlation between past feedbacks having a higher priority. Note that, at some feedback timings, the CSI (feedback bit) having a lower priority may be dropped. Note that, in the present disclosure, “drop” may be interchangeably interpreted as cancel, defer transmission, not transmit, ignore, discard, and the like.

CSI estimation using the reduced CSI feedback may be performed in accordance with the following Steps S201 and S202.

In Step S201, the UE transmits the partial CSI including the CSI information corresponding to a different priority for each feedback timing to the BS. Note that, as will be described later, the partial CSI in the second embodiment is not limited to the subband CSI.

In Step S202, the BS may predict the full CSI information at a future time (for example, specific TTI, slot, or the like), using an AI model, based on the partial CSI transmitted in Step S201.

Note that the full CSI information may mean the CSI information regarding the entire priority corresponding to each partial CSI. In the second embodiment, the partial CSI is also referred to as CSI of a given priority.

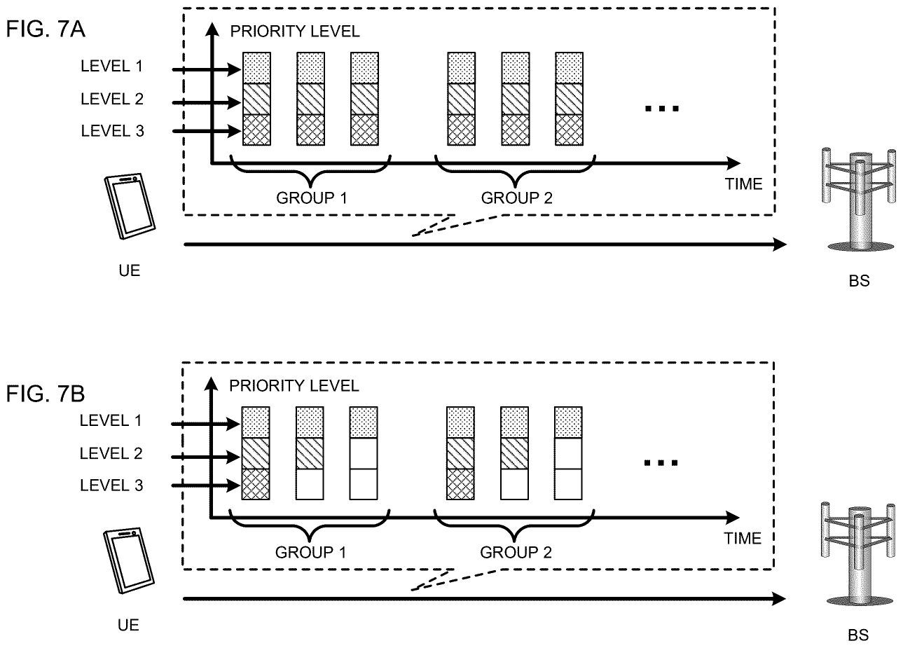

FIGS. 7A and 7B are diagrams to show examples of the reduced CSI feedback according to the second embodiment. In the present example, it is assumed that CSIs of three priority levels (levels 1, 2, and 3) are defined. The present disclosure will be described on an assumption that a smaller number of a level indicates a higher priority; however, this is not restrictive.

In the present example, two feedback groups (groups 1 and 2) are indicated. One feedback group may correspond to feedback (feedback timing) in some TTIs (for example, some consecutive TTIs). The feedback group will be described later.

FIG. 7A shows an example in which the full CSI feedback is performed from the beginning, unlike the second embodiment. In FIG. 7A, the UE feeds back the CSIs regarding all of the priorities.

FIG. 7B shows an example in which the reduced CSI feedback is performed. In FIG. 7B, in each group, the UE reports the CSI of all of the levels at a first feedback timing, reports the CSI of levels 1 and 2 at a second feedback timing, and reports only the CSI of level 1 at a third feedback timing. It can be understood that, in FIG. 7B, communication overhead for CSI feedback is reduced as compared to that of FIG. 7A.

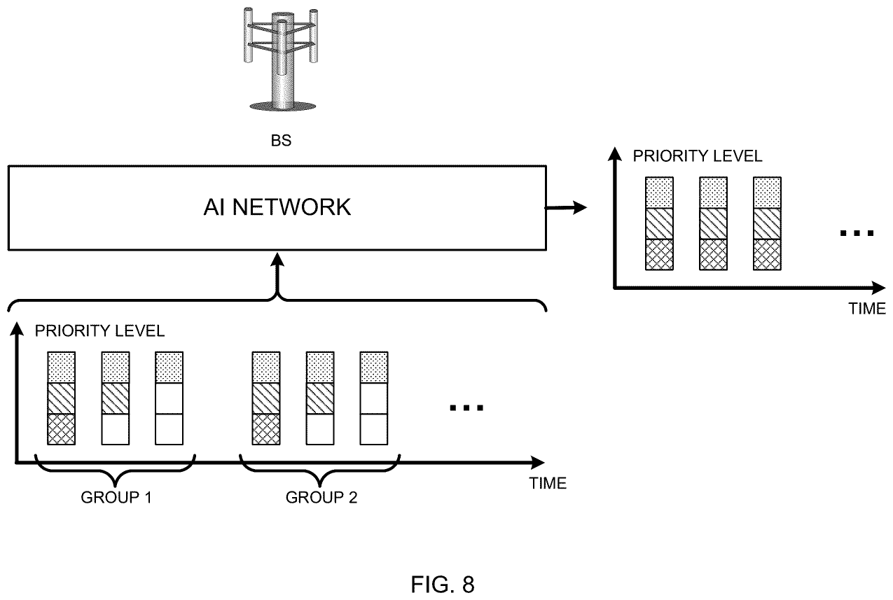

FIG. 8 is a diagram to show an example of prediction of full CSI based on the reduced CSI feedback according to the second embodiment.

In FIG. 8, the BS inputs the reduced CSI feedback in groups 1 and 2 received from the UE to an AI model (AI network), and predicts the full CSI in the following groups (timings).

Note that prediction of the full CSI of the second embodiment may be used for prediction of the full CSI with a period/timing different from a transmission period of the reduced CSI feedback. Prediction of the full CSI of the second embodiment may be used for prediction of the full CSI at the transmission timing of the reduced CSI feedback.

Note that, in the present disclosure, as CSI measurement for the reduced CSI feedback, the UE may perform CSI measurement of the entire priority (i.e., may perform CSI measurement also regarding the priorities not to be reported), or may perform CSI measurement of only the priorities to be reported. In the former case, measurement results of the priorities not to be reported can be used for control/processing, whereas in the latter case, a measurement load of the UE can be reduced.

### [Determination of Priority]

In the reduced CSI feedback, the UE may determine the priority corresponding to the CSI (or the CSI corresponding to a given priority), based on one of the following elements 1 to 3 or a combination of these:
Element 1: subband/a set of subbands/subband group,
Element 2: whether it is a wideband CSI or a subband CSI,
Element 3: information transmitted on the CSI.

Regarding element 1, for example, the UE may determine that the CSI related to a first subband/set of subbands/subband group has a priority different from that of the CSI related to a second subband/set of subbands/subband group. Note that the set of subbands/subband group may be configured/determined/defined similarly to the patterns described in the first embodiment.

Regarding element 2, for example, the UE may determine that the wideband CSI has a priority higher/lower than that of the subband CSI.

Regarding element 3, for example, the UE may determine the priority of the CSI, based on which is included in the CSI, out of a channel quality indicator (CQI), a precoding matrix indicator (PMI), a CSI-RS resource indicator (CRI), an SS/PBCH block resource indicator (SS/PBCH Block Indicator (SSBRI)), a layer indicator (LI), a rank indicator (RI), L1-RSRP (layer 1 reference signal received power), L1-RSRQ (Reference Signal Received Quality), an L1-SINR (Signal-to-Noise and Interference Ratio or Signal to Interference plus Noise Ratio), an L1-SNR (Signal to Noise Ratio), and the like.

For example, the priority of a given CSI report may be determined based on report quantity information (which may be indicated by “report quantity” or an RRC parameter “reportQuantity”) included in the CSI report configuration information (CSI-ReportConfig) for the CSI report.

Regarding element 3, the UE may determine the priority of the CSI, based on to which the CSI corresponds, out of part 1 CSI, part 2 CSI, type 1 CSI, and type 2 CSI.

Note that the type 1 CSI may correspond to the CSI of a type used for selection of a single beam, and the type 2 CSI may correspond to the CSI of a type used for selection of a multi-beam. The single beam may be interpreted as a single layer, and the multi-beam may be interpreted as a plurality of beams. The type 1 CSI may not assume multi-user multiple input multiple output (MIMO), and the type 2 CSI may assume multi-user MIMO. The type 1 CSI may include type 1 single panel CSI and type 1 multi-panel CSI.

Regarding element 3, the UE may determine the priority of the CSI, based on a codebook (a codebook type, a codebook sub-type, or the like) used for determination of the CSI (PMI). The codebook may include a codebook for the type 1 CSI (also referred to as a type 1 codebook) and a codebook for the type 2 CSI (also referred to as a type 2 codebook).

Note that, regarding the priority of the CSI, the UE may perform determination based on a specific rule, may be configured using physical layer signaling (for example, DCI), higher layer signaling (for example, RRC signaling or a MAC CE), or a specific signal/channel, or a combination of these, or may perform determination based on a UE capability.

For example, the UE may be configured with priority levels for respective subbands. The UE may prioritize the CSIs so that the AI of the BS can reconstruct accurate full CSI, using high-priority CSI.

The UE may determine the priority of the CSI, based on the CSI information. For example, the UE may calculate a difference between the CSI (also including the CSI not to be reported) measured at the time of a previous report and the CSI measured at present, and determine the priority of the CSI, based on this. The UE may determine X subsets that have changed the most (from the one with the largest difference) from the CSI measured at the time of a previous report as the CSI having a higher priority. Here, the subset may be interchangeably interpreted as a subband, a subband group, or the like. Note that the subsets as a report target may be determined from a subset whose difference has exceeded a threshold.

Regarding the value of X, the threshold, and the like, the UE may perform determination based on a specific rule, may be configured using physical layer signaling (for example, DCI), higher layer signaling (for example, RRC signaling or a MAC CE), or a specific signal/channel, or a combination of these, or may perform determination based on a UE capability.

Regarding at which timing the CSI of which priority is to be reported, the UE may perform determination based on a specific rule, may be configured using physical layer signaling (for example, DCI), higher layer signaling (for example, RRC signaling or a MAC CE), or a specific signal/channel, or a combination of these, or may perform determination based on a UE capability.

For example, the UE may determine the CSI to be transmitted at each transmission timing, based on information (for example, a bitmap) indicating the priority of the CSI to be transmitted at each transmission timing in the group. The bitmap may be configured for each priority level. The size of the bitmap may correspond to the number of transmission timings in the group. Regarding the bitmap of a given priority level, the UE may determine to report the CSI having the priority at the transmission timing corresponding to value=‘1’, and not to report the CSI having the priority at the transmission timing corresponding to value=‘0’ (note that these values may be the opposite). In the bitmap, the MSB may correspond to the first transmission timing or may correspond to the last transmission timing in the group.

The UE may be configured with a CSI reporting period for each priority level, and determine the CSI to be transmitted at each transmission timing, based on this. In this case, the group need not be defined/configured (the group need not be recognized).

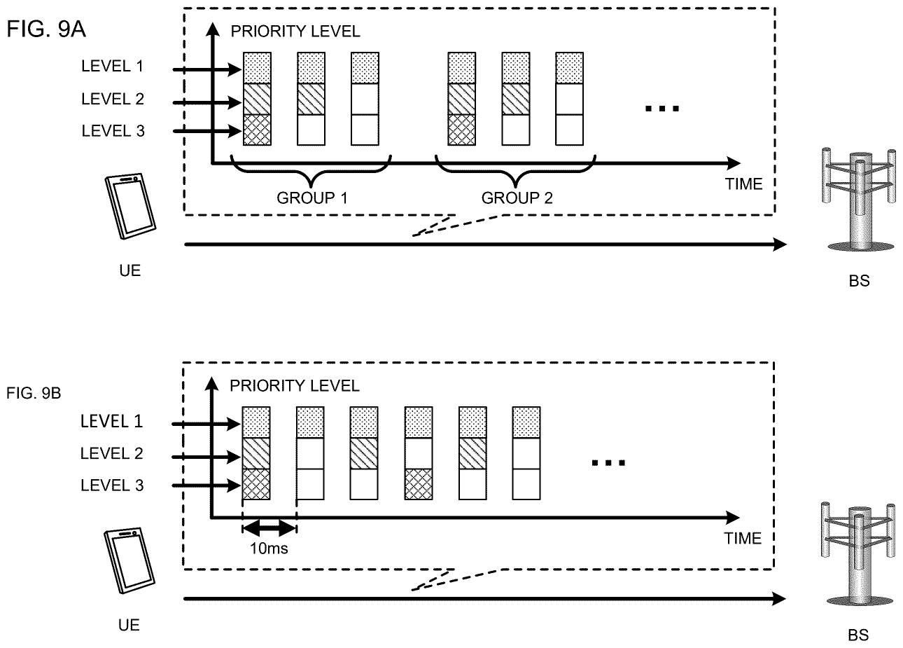

FIGS. 9A and 9B are diagrams to show examples of determination of details of the reduced CSI feedback according to the second embodiment.

FIG. 9A shows an example of determining details of the reduced CSI feedback, based on the bitmap for each priority level. In the present example, the UE is configured with “111” as the bitmap for level 1, “110” as the bitmap for level 2, and “100” as the bitmap for level 3.

FIG. 9B shows an example of determining details of the reduced CSI feedback, based on the CSI reporting period for each priority level. In the present example, the UE is configured with 10 ms as the reporting period for level 1, 20 ms as the reporting period for level 2, and 30 ms as the reporting period for level 3.

According to the second embodiment described above, the UE can implement the reduced CSI feedback with low overhead.

### Other Embodiments

It is preferable that the complementary CSI feedback/reduced CSI feedback described above be configurable with one CSI report configuration (RRC information element CSI-ReportConfig). According to the complementary CSI feedback/reduced CSI feedback of the present disclosure, for example, regarding periodic CSI feedback for a given CSI reporting band, the UE can select the subbands to be reported dynamically (for example, autonomously) out of the CSI reporting band even without RRC reconfiguration. As compared to a case in which an aperiodic CSI report regarding different subbands is triggered using multiple triggering DCIs to be reported, according to the complementary CSI feedback/reduced CSI feedback of the present disclosure, for example, different subbands can be reported using periodic CSI feedback, without triggering DCI.

In the present disclosure, description is given based on an assumption that the prediction value is one value, but this is not restrictive. For example, the prediction value may be calculated as a probability density function (PDF)/cumulative distribution function (CDF).

At least one of the embodiments described above may be applied only to the UE that has reported a specific UE capability or that supports the specific UE capability.

The specific UE capability may indicate at least one of the following:
whether or not specific operation/information (for example, the complementary CSI feedback or the reduced CSI feedback) of each embodiment is supported,
whether or not prioritization of (details of) the CSIs is supported,
performance of prioritization of (details of) the CSIs.

The UE capability may be reported for each frequency, may be reported for each frequency range (for example, Frequency Range 1 (FR1), Frequency Range 2 (FR2), FR2-1, or FR2-2), may be reported for each cell, or may be reported for each subcarrier spacing (SCS).

The UE capability may be reported in common to time division duplex (TDD) and frequency division duplex (FDD), or may be reported independently.

At least one of the embodiments described above may be applied when the UE is configured with specific information related to the embodiments described above, using higher layer signaling. For example, the specific information may be information indicating enabling of the reduced CSI feedback/reduced CSI feedback, any RRC parameter for a specific release (for example, Rel. 18), or the like.

For example, when the complementary CSI feedback/reduced CSI feedback is used, as values of RRC parameters (cqi-FormatIndicator, pmi-FormatIndicator) indicating a report format (a wideband or a subband) of the CQI/PMI, values different from the wideband/subband may be indicated.

### (Radio Communication System)

Hereinafter, a structure of a radio communication system according to one embodiment of the present disclosure will be described. In this radio communication system, the radio communication method according to each embodiment of the present disclosure described above may be used alone or may be used in combination for communication.

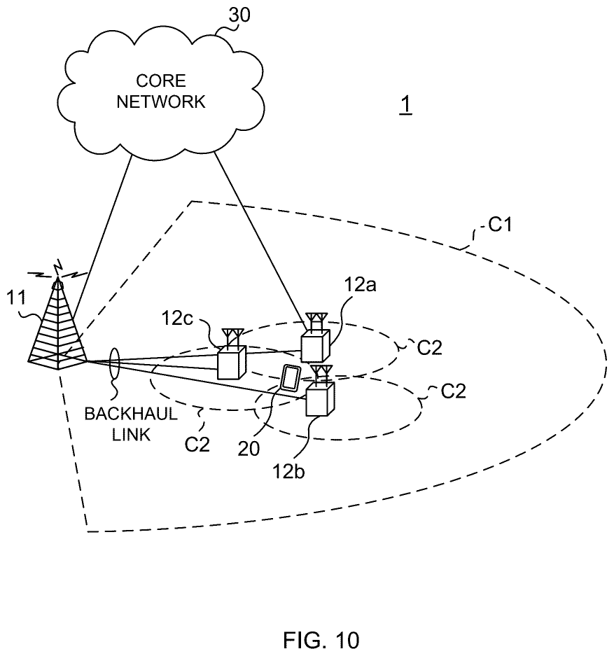

FIG. 10 is a diagram to show an example of a schematic structure of the radio communication system according to one embodiment. The radio communication system 1 may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub-6 GHZ), and FR2 may be a frequency band which is higher than 24 GHZ (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data”, and the PUSCH may be interpreted as “UL data”.

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a given search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be also referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be also referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal).”

### (Base Station)

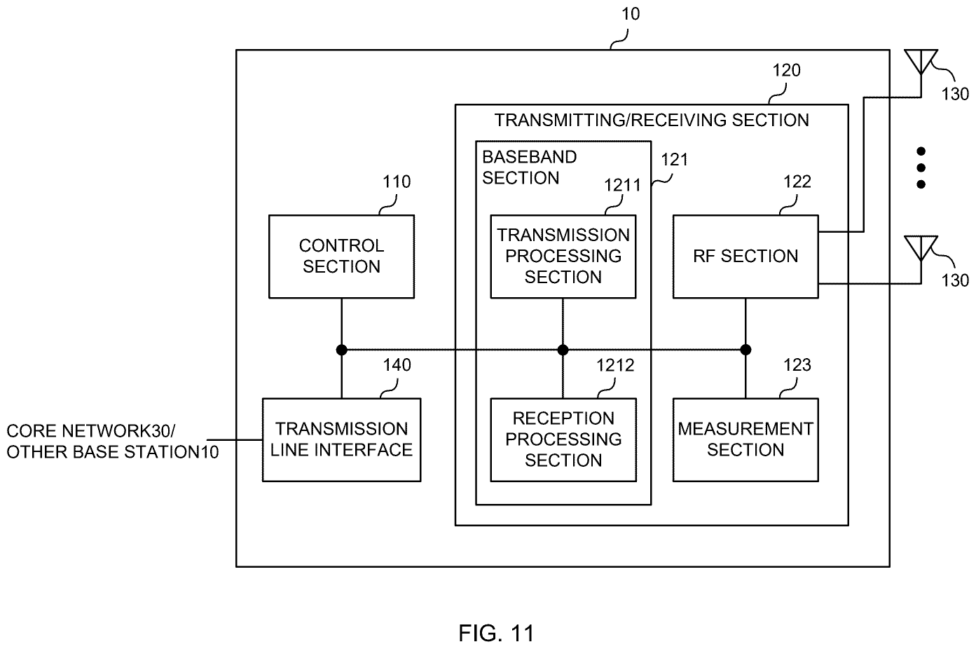

FIG. 11 is a diagram to show an example of a structure of the base station according to one embodiment. The base station 10 includes a control section 110, a transmitting/receiving section 120, transmitting/receiving antennas 130 and a communication path interface (transmission line interface) 140. Note that the base station 10 may include one or more control sections 110, one or more transmitting/receiving sections 120, one or more transmitting/receiving antennas 130, and one or more communication path interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the communication path interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The communication path interface 140 may perform transmission/reception (backhaul signaling) of a signal with an apparatus included in the core network 30 or other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the communication path interface 140.

Note that the transmitting/receiving section 120 may transmit one channel state information (CSI) report configuration to the user terminal 20.

The control section 110 may perform control of receiving first CSI at a first timing transmitted by the user terminal 20 based on the one CSI report configuration, and second CSI being different from the first CSI at a second timing being different from the first timing.

The transmitting/receiving section 120 may receive the first channel state information (CSI) at the first timing, and receive the second CSI being different from the first CSI at a timing being different from the first timing.

The control section 110 may estimate the first CSI and the second CSI at a third timing being different from the first timing and the second timing, based on the first CSI at the first timing and the second CSI at the second timing.

### (User Terminal)

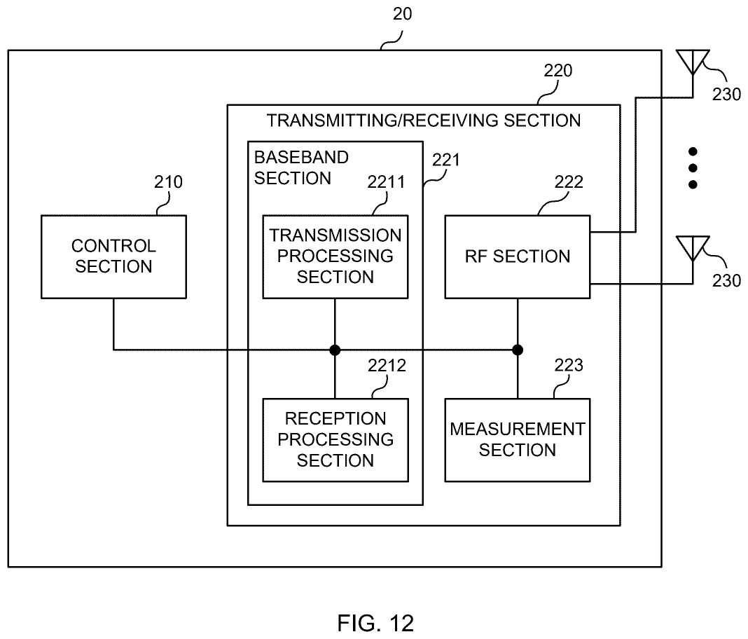

FIG. 12 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a given channel (for example, PUSCH), the DFT processing as the above-described transmission processing to transmit the channel by using a DFT-s-OFDM waveform if transform precoding is enabled, and otherwise, does not need to perform the DFT processing as the above-described transmission process.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply a receiving process such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220, the transmitting/receiving antennas 230, and the communication path interface 240.

Note that the transmitting/receiving section 220 may receive one channel state information (CSI) report configuration.

The control section 210 may perform control of transmitting first CSI at a first timing and second CSI being different from the first CSI at a second timing being different from the first timing, based on the one CSI report configuration.

Note that the first CSI may be CSI of a first subband, and the second CSI may be CSI of a second subband being different from the first subband (complementary CSI feedback).

The first CSI may be CSI having a first priority, and the second CSI may be CSI having a second priority being different from the first priority (reduced CSI feedback).

### (Hardware Structure)

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining softwares into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

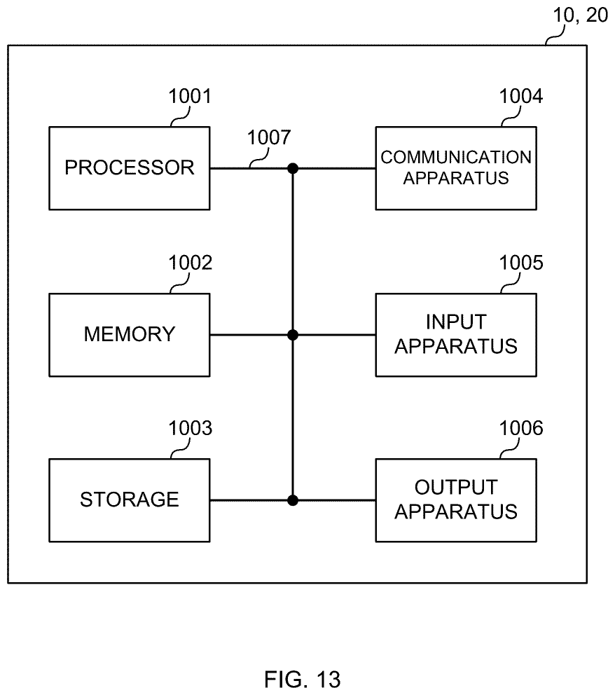

For example, a base station, a user terminal, and so on according to one embodiment of the present disclosure may function as a computer that executes the processes of the radio communication method of the present disclosure. FIG. 13 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably interpreted. The hardware structure of the base station 10 and the user terminal 20 may be configured to include one or more of apparatuses shown in the drawings, or may be configured not to include part of apparatuses.

For example, although only one processor 1001 is shown, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminals 20 is implemented, for example, by allowing given software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least part of the above-described control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmitting/receiving section 120 (220), the transmitting/receiving antennas 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the base station 10 and the user terminals 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

### (Variations)

Note that the terminology described in the present disclosure and the terminology that is needed to understand the present disclosure may be replaced by other terms that convey the same or similar meanings. For example, a “channel,” a “symbol,” and a “signal” (or signaling) may be interchangeably interpreted. Also, “signals” may be “messages.” A reference signal may be abbreviated as an “RS,” and may be referred to as a “pilot,” a “pilot signal,” and so on, depending on which standard applies. Furthermore, a “component carrier (CC)” may be referred to as a “cell,” a “frequency carrier,” a “carrier frequency” and so on.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a given signal or channel. For example, numerology may indicate at least one of a subcarrier spacing (SCS), a bandwidth, a symbol length, a cyclic prefix length, a transmission time interval (TTI), the number of symbols per TTI, a radio frame structure, a particular filter processing performed by a transceiver in the frequency domain, a particular windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably interpreted.

For example, one subframe may be referred to as a “TTI,” a plurality of consecutive subframes may be referred to as a “TTI,” or one slot or one mini-slot may be referred to as a “TTI.” That is, at least one of a subframe and a TTI may be a subframe (1 ms) in existing LTE, may be a shorter period than 1 ms (for example, 1 to 13 symbols), or may be a longer period than 1 ms. Note that a unit expressing TTI may be referred to as a “slot,” a “mini-slot,” and so on instead of a “subframe.”

Here, a TTI refers to the minimum time unit of scheduling in radio communication, for example. For example, in LTE systems, a base station schedules the allocation of radio resources (such as a frequency bandwidth and transmit power that are available for each user terminal) for the user terminal in TTI units. Note that the definition of TTIs is not limited to this.

TTIs may be transmission time units for channel-encoded data packets (transport blocks), code blocks, or codewords, or may be the unit of processing in scheduling, link adaptation, and so on. Note that, when TTIs are given, the time interval (for example, the number of symbols) to which transport blocks, code blocks, codewords, or the like are actually mapped may be shorter than the TTIs.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot” and so on. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),” a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for given numerology in a given carrier. Here, a common RB may be specified by an index of the RB based on the common reference point of the carrier. A PRB may be defined by a given BWP and may be numbered in the BWP.

The BWP may include a UL BWP (BWP for the UL) and a DL BWP (BWP for the DL). One or a plurality of BWPs may be configured in one carrier for a UE.

At least one of configured BWPs may be active, and a UE does not need to assume to transmit/receive a given signal/channel outside active BWPs. Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in the present disclosure may be represented in absolute values or in relative values with respect to given values, or may be represented in another corresponding information. For example, radio resources may be specified by given indices.

The names used for parameters and so on in the present disclosure are in no respect limiting. Furthermore, mathematical expressions that use these parameters, and so on may be different from those expressly disclosed in the present disclosure. For example, since various channels (PUCCH, PDCCH, and so on) and information elements can be identified by any suitable names, the various names allocated to these various channels and information elements are in no respect limiting.

The information, signals, and so on described in the present disclosure may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output in at least one of from higher layers to lower layers and from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Reporting of information is by no means limited to the aspects/embodiments described in the present disclosure, and other methods may be used as well. For example, reporting of information in the present disclosure may be implemented by using physical layer signaling (for example, downlink control information (DCI), uplink control information (UCI), higher layer signaling (for example, Radio Resource Control (RRC) signaling, broadcast information (master information block (MIB), system information blocks (SIBs), and so on), Medium Access Control (MAC) signaling and so on), and other signals or combinations of these.

Note that physical layer signaling may be referred to as “Layer 1/Layer 2 (L1/L2) control information (L1/L2 control signals),” “L1 control information (L1 control signal),” and so on. Also, RRC signaling may be referred to as an “RRC message,” and can be, for example, an RRC connection setup message, an RRC connection reconfiguration message, and so on. Also, MAC signaling may be reported using, for example, MAC control elements (MAC CEs).

Also, reporting of given information (for example, reporting of “X holds”) does not necessarily have to be reported explicitly, and can be reported implicitly (by, for example, not reporting this given information or reporting another piece of information).

Determinations may be made in values represented by one bit (0 or 1), may be made in Boolean values that represent true or false, or may be made by comparing numerical values (for example, comparison against a given value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using at least one of wired technologies (coaxial cables, optical fiber cables, twisted-pair cables, digital subscriber lines (DSL), and so on) and wireless technologies (infrared radiation, microwaves, and so on), at least one of these wired technologies and wireless technologies are also included in the definition of communication media.

The terms “system” and “network” used in the present disclosure can be used interchangeably. The “network” may mean an apparatus (for example, a base station) included in the network.

In the present disclosure, the terms such as “precoding,” a “precoder,” a “weight (precoding weight),” “quasi-co-location (QCL),” a “Transmission Configuration Indication state (TCI state),” a “spatial relation,” a “spatial domain filter,” a “transmit power,” “phase rotation,” an “antenna port,” an “antenna port group,” a “layer,” “the number of layers,” a “rank,” a “resource,” a “resource set,” a “resource group,” a “beam,” a “beam width,” a “beam angular degree,” an “antenna,” an “antenna element,” a “panel,” and so on can be used interchangeably.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be device mounted on a moving object or a moving object itself, and so on. The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor, and the like.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D),” “Vehicle-to-Everything (V2X),” and the like). In this case, user terminals 20 may have the functions of the base stations 10 described above. The words “uplink” and “downlink” may be interpreted as the words corresponding to the terminal-to-terminal communication (for example, “sidelink”). For example, an uplink channel, a downlink channel and so on may be interpreted as a sidelink channel.

Likewise, the user terminal in the present disclosure may be interpreted as base station. In this case, the base station 10 may have the functions of the user terminal 20 described above.

Actions which have been described in the present disclosure to be performed by a base station may, in some cases, be performed by upper nodes. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

The aspects/embodiments illustrated in the present disclosure may be used individually or in combinations, which may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG) (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced based on these. A plurality of systems may be combined (for example, a combination of LTE or LTE-A and 5G, and the like) and applied.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “judging (determining)” as in the present disclosure herein may encompass a wide variety of actions. For example, “judging (determining)” may be interpreted to mean making “judgments (determinations)” about judging, calculating, computing, processing, deriving, investigating, looking up, search and inquiry (for example, searching a table, a database, or some other data structures), ascertaining, and so on.

Furthermore, “judging (determining)” may be interpreted to mean making “judgments (determinations)” about receiving (for example, receiving information), transmitting (for example, transmitting information), input, output, accessing (for example, accessing data in a memory), and so on.

In addition, “judging (determining)” as used herein may be interpreted to mean making “judgments (determinations)” about resolving, selecting, choosing, establishing, comparing, and so on. In other words, “judging (determining)” may be interpreted to mean making “judgments (determinations)” about some action.

In addition, “judging (determining)” may be interpreted as “assuming,” “expecting,” “considering,” and the like.

“The maximum transmit power” according to the present disclosure may mean a maximum value of the transmit power, may mean the nominal maximum transmit power (the nominal UE maximum transmit power), or may mean the rated maximum transmit power (the rated UE maximum transmit power).

The terms “connected” and “coupled,” or any variation of these terms as used in the present disclosure mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other.” Note that the phrase may mean that “A and B is each different from C.” The terms “separate,” “be coupled,” and so on may be interpreted similarly to “different.”

When terms such as “include,” “including,” and variations of these are used in the present disclosure, these terms are intended to be inclusive, in a manner similar to the way the term “comprising” is used. Furthermore, the term “or” as used in the present disclosure is intended to be not an exclusive disjunction.

For example, in the present disclosure, when an article such as “a,” “an,” and “the” in the English language is added by translation, the present disclosure may include that a noun after these articles is in a plural form.

Now, although the invention according to the present disclosure has been described in detail above, it should be obvious to a person skilled in the art that the invention according to the present disclosure is by no means limited to the embodiments described in the present disclosure. The invention according to the present disclosure can be implemented with various corrections and in various modifications, without departing from the spirit and scope of the invention defined by the recitations of claims. Consequently, the description of the present disclosure is provided only for the purpose of explaining examples, and should by no means be construed to limit the invention according to the present disclosure in any way.

1. A terminal comprising:
a receiving section that receives one channel state information (CSI) report configuration; and
a control section that performs control of transmitting first CSI at a first timing and second CSI being different from the first CSI at a second timing being different from the first timing, based on the one CSI report configuration.

2. The terminal according to claim 1, wherein
the first CSI is CSI of a first subband, and the second CSI is CSI of a second subband being different from the first subband.

3. The terminal according to claim 1, wherein
the first CSI is CSI having a first priority, and the second CSI is CSI having a second priority being different from the first priority.

4. A radio communication method for a terminal, the radio communication method comprising:
receiving one channel state information (CSI) report configuration; and
performing control of transmitting first CSI at a first timing and second CSI being different from the first CSI at a second timing being different from the first timing, based on the one CSI report configuration.

5. A base station comprising:
a transmitting section that transmits one channel state information (CSI) report configuration to a terminal; and
a control section that performs control of receiving first CSI at a first timing transmitted by the terminal based on the one CSI report configuration, and second CSI being different from the first CSI at a second timing being different from the first timing.
